(19) United States
(12) Patent Application Publication
(10) Pub. No.: US 2006/0276924 A1
(43) Pub. Date: Dec. 7, 2006

(54) Method and system for remote controlling the current status of a production process of an article having a number of production process steps

(76) Inventor: Mario Spatafora, Granarolo (IT)

Correspondence Address: HARNESS, DICKEY & PIERCE, P.L.C., P.O.BOX 8910, RESTON, VA, 20195, US

(21) Appl. No.: 10/569,092

(22) PCT Filed: Aug. 25, 2004
(86) PCT No.: PCT/EP04/51898

§ 371 Date: Aug. 14, 2006

(30) Foreign Application Priority Data
Aug. 26, 2003 (IT) BO2003A000500

(51) Int. Cl. G06F 19/00

(52) U.S. Cl. 700/115; 235/376

(57) ABSTRACT

A method and system for remote controlling the current status of a production process of an article having a number of production process steps; whereby a user, by means of a pickup device, communicates confirmation of completion of a production process step to a central control unit, which stores the current status of the production process of the article in a database; and the pickup device is defined by a cellular telephone, which communicates with the central control unit by sending SMS messages.

### TECHNICAL FIELD

The present invention relates to a method and system for remote controlling the current status of the production process of an article having a number of production process steps.

The present invention may be used to advantage in the metalworking industry for manufacturing mechanical parts, to which the following description refers purely by way of example.

### BACKGROUND ART

A metalworking firm manufacturing complex articles, i.e. comprising numerous assembled parts, does not normally produce all the parts itself, but subcontracts production, or at least part of it, of some of the parts to outside firms. The decision to do this depends on various factors. For example, the firm may not have the machinery or personnel to handle certain jobs, and purchasing the machinery or acquiring additional personnel may prove difficult and/or economically unfeasible.

Subcontracting parts, however, may pose problems, by the firm losing direct control of the production process of the parts subcontracted out. That is, the firm no longer has direct control over progress and scheduling of the production process of the subcontracted parts, and must rely solely on agreements made with subcontractors.

In the past, to avoid problems caused by subcontractors failing to deliver on time, large stocks were maintained in contractors' warehouses. Given the rising cost of warehousing large stocks, however, metalworking firms currently implement a “just in time” warehousing policy, with stocks reduced to a bare minimum. Firms dealing with subcontractors are therefore currently faced with the problem of how to control the production process of subcontracted parts, so as to avoid, or at least predict in time, any delay in delivery on the part of the subcontractor.

To control the production process of subcontracted parts, one possible solution is for the subcontractor to be equipped with one of various currently marketed computerized production process control systems. This, however, is only feasible in the case of major subcontractors with advanced computer equipment, in that computerized production process control systems are expensive, are logistically complex, and call for connecting all the subcontractor work stations to a central data collection system.

EP-1164450-A1 discloses a monitoring device for at least one state parameter of an object; the monitoring device has at least one sensor for detecting the state parameters and at least one transmitter connected to the sensor for transmitting the state parameters or associated information. At least one converter converts the data received from the sensor into graphical representations and at least one mobile radio device wirelessly connected to the transmitter has a display for outputting the graphical representation.

DE10147744-A1 discloses a process visualization system connected to a mix of sensors and actuators by means of a field bus; the visualization system has distributed computers coupled by a communication unit to a server (connected with the Internet) via a local area network (LAN)

DE19962230-A1 discloses an industrial control system, in which devices for registering of reports or alarms for predefined operating conditions are available; these predefined operating conditions are processed through a converter so that they can be sent via a short message service report or an e-mail to a predefined distribution circuit according to the nature of the operating condition encountered. The report or alarm can be sent on one message circuit based on lists of personnel and locations, type of message to be sent, e.g. e-mail or SMS format and can include files for attachment to the message.

### DISCLOSURE OF INVENTION

It is an object of the present invention to provide a method and system of remote controlling the production process of an article, which provide for solving the aforementioned problems, and which at the same time are cheap and easy to implement.

According to the present invention, there is provided a method and a system of remote controlling the current status of the production process of an article having a number of production process steps as recited in the attached claims.

### BRIEF DESCRIPTION OF THE DRAWINGS

A number of non-limiting embodiments of the present invention will be described by way of example with reference to the accompanying drawings, in which:

FIG. 1 shows, schematically, a system for remote controlling the production process of an article in accordance with the present invention;

FIG. 2 shows, schematically, an article controlled by the FIG. 1 system;

FIG. 3 shows, schematically, a printed sheet forming part of the FIG. 1 system;

FIG. 4 shows a schematic view in perspective of a pickup device of the FIG. 1 system;

FIG. 5 shows, schematically, a further embodiment of a system for remote controlling the production process of an article in accordance with the present invention.

### BEST MODE FOR CARRYING OUT THE INVENTION

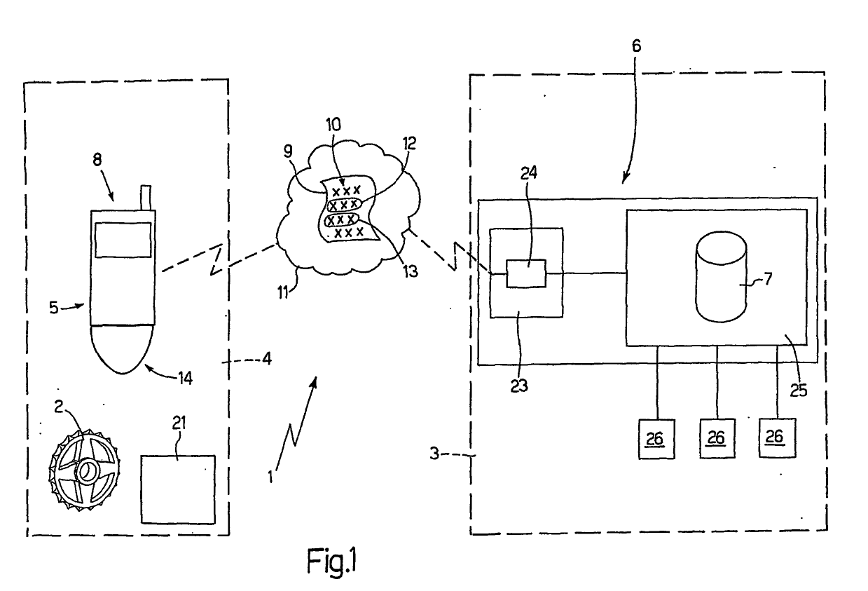

Number 1 in FIG. 1 indicates as a whole a system for remote controlling the production process of a mechanical part 2. More specifically, mechanical part 2 is subtracted by a metalworking firm 3 to a subcontractor 4, so that subcontractor 4 produces part 2 on behalf of firm 3. The production process of part 2 comprises a series of steps which must be performed successively by an operator of subcontractor 4.

System 1 comprises a pickup device 5, which receives confirmation of completion of a production process step from a user; and a central control unit 6 connected to pickup device 5 and for storing the current status of the production process of part 2 in a database 7. Database 7 is of substantially known type, and comprises a series of records (not shown in detail), each of which relates to, and contains the history of, a respective part 2. Pickup device 5 and part 2 are obviously located physically at the plant of subcontractor 4 producing part 2, whereas control unit 6 is physically located at firm 3.

Pickup device 5 comprises a mobile telephone communication device 8, which communicates with central control unit 6 by sending SMS messages 9. More specifically, pickup device 5 codes confirmation of completion of a step in the production process of part 2 into an alphanumeric code 10, inserts code 10 into an SMS message 9, and sends the SMS message 9 to central control unit 6 over a mobile telephone network 11.

Code 10 preferably contains a sequence 12 identifying the completed production process step, and a sequence 13 identifying part 2. On receiving an SMS message 9 from pickup device 5, control unit 6 is therefore able to identify the part 2 in question, and the relative production process step that has been completed. Since subcontractor 4, in fact, actually produces a lot of parts 2 of the same type or a number of lots of parts 2 of different types simultaneously, control unit 6 must be able to identify not only the production process step that has been completed, but also the part 2 in question, or at least the lot to which part 2 refers.

In a preferred embodiment shown in more detail in FIG. 4, pickup device 5 is defined by a cellular telephone 8 equipped with a bar code reading device 14. Reading device 14 is detachable from cellular telephone 8, and comprises a communication port 15 which fits inside a similar communication port 16 of cellular telephone 8 when bar code reading device 14 is connected to cellular telephone 8. Reading device 14 may have and be controlled by a number of buttons 17, or may have no buttons and be controlled using the keys on cellular telephone 8.

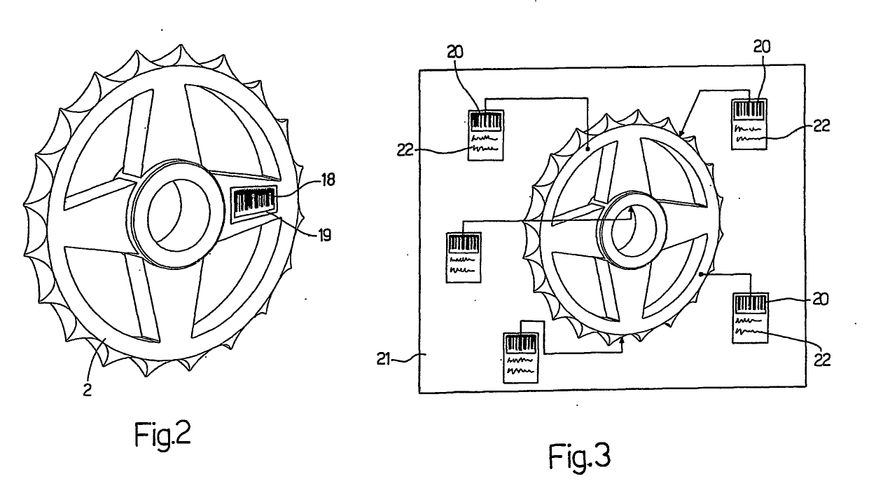

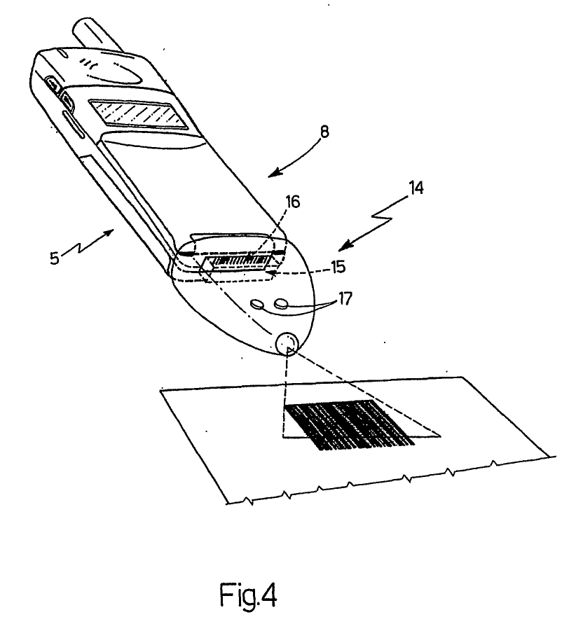

As shown in FIGS. 2 and 3, sequence 13 is communicated to pickup device 5 by pickup device 5 reading a relative bar code 18 printed on a label 19 associated with part 2. Label 19 may be attached directly to part 2, as shown in FIG. 2, or may be attached to a production card (not shown) of part 2, or to a drawing of part 2.

Sequence 12 is communicated to pickup device 5 by pickup device 5 reading a relative bar code 20. Preferably, a sheet 21 is provided, on which is printed a series of bar codes 20, each relating to a given production process step. Next to each bar code 20 printed on sheet 21, a description 22 of the corresponding production process step is preferably also printed, and comprises verbal and/or pictorial information. Sheet 21 may also contain a drawing or the production cycle of part 2.

As shown in FIG. 1, central control unit 6 comprises an interface computer 23 having a mobile telephone communication device 24; and a main computer 25 in which database 7 is stored. Communication device 24 is preferably defined by a mobile telephone communication card inserted inside interface computer 23. Whereas interface computer 23 serves solely for communicating with pickup devices 5, main computer 25 may also be used for processing information concerning production or assembly processes carried out directly by firm 3. In other words, database 7 may contain not only records relative to parts 2 being produced by subcontractor 4, but also records relative to all the parts 2 produced internally by firm 3 or by subcontractors 4. Data relating to parts 2 produced within firm 3 is obviously communicated to main computer 25 by data acquisition devices 26 connected to main computer 25 over the firm's communication network.

On receiving an SMS message 9 containing a respective code 10 from pickup device 5, control unit 6 may send pickup device 5 a further SMS message confirming reception. In which case, pickup device 5 only eliminates an SMS message 9 containing a respective code 10 from its own memory on receiving the respective further SMS message confirming reception from control unit 6.

In actual use, on completing a step in the production process of part 2, an operator of subcontractor 4, using pickup device 5, reads bar code 18 identifying part 2, and then reads bar code 20 identifying the step in the production process of part 2. Obviously, the information in code 18 could also be contained in code 20. At this point, pickup device 5 sends an SMS message 9 containing code 10 to control unit 6; and, on determining correct reception of SMS message 9, control unit 6 sends pickup device 5 a further SMS message confirming reception.

On receiving an SMS message 9 containing a respective code 10, control unit 6 identifies the completed production process step by means of sequence 12 in code 10, identifies part 2 by means of sequence 13 in code 10, and accordingly updates database 7 by entering completion of the production process step in a record relative to the part 2 in question.

It should be pointed out that the term production process step of part 2 refers to any type of operation or sequence of operations relating to a part 2. For example, a production process step may even be a dimensional check or rejection of a ruined part (even as a result of a processing error).

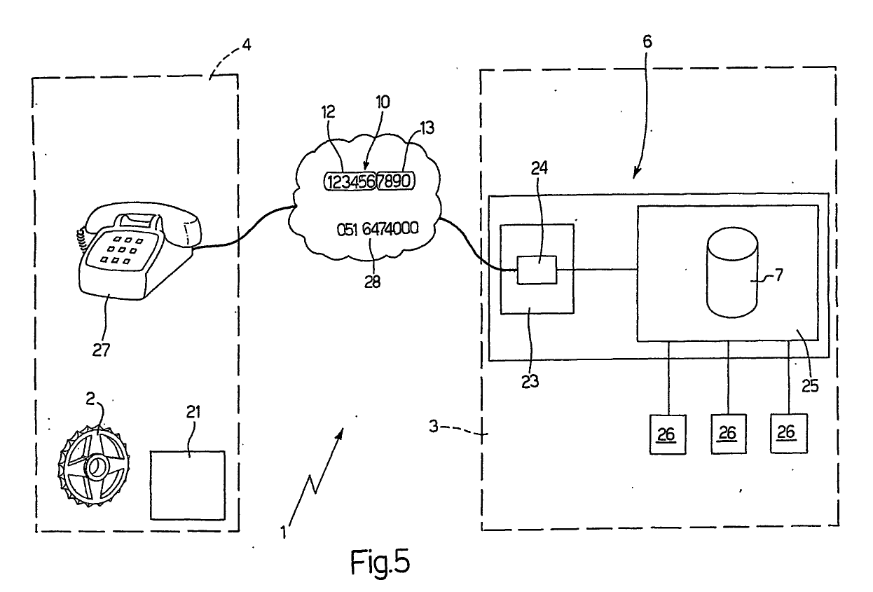

In an alternative embodiment shown in FIG. 5, pickup device 5 is dispensed with, and, upon completion of a production process step of part 2, an operator codes completion confirmation by means of a respective numeric code 10, and transmits code 10 to central control unit 6 over a telephone 27, connected to a fixed telephone network, by keying a given telephone number 28 associated with control unit 6.

In a first embodiment, code 10 corresponds with the telephone number 28 keyed by the user. That is, on determining an incoming call to telephone number 28, control unit 6 is informed that a respective production process step of part 2 associated with the telephone number 28 called has been completed. Each production process step of part 2 is assigned a respective telephone number 28, i.e. a respective code 10 corresponding with telephone number 28, and a call made to telephone number 28 informs control unit 6 that the production process step of part 2 associated with the telephone number 28 called has been completed. It should be pointed out that, in known manner, control unit 6 can identify the telephone number of the telephone 27 from which the call is made, and so identify the caller.

In a second embodiment, code 10 is completely independent of the telephone number 28 keyed by the user. That is, on keying telephone number 28, the user connects respective telephone 27 to control unit 6, and, once the connection is made, transmits code 10 to control unit 6 by keying code 10 on the keyboard of telephone 27.

In a further embodiment, which is halfway between the two described above, a first part of code 10 corresponds with telephone number 28 keyed by the user.

Code 10 preferably comprises sequence 12 identifying the relative production process step, and sequence 13 identifying part 2. More specifically, sequence 13 is printed on a label 19 associated with part 2, and sequence 12 is printed on sheet 21 together with other sequences 12 relative to other production process steps.

System 1 described above allows a firm 3 complete, real-time control of the production process of part 2 carried out by a subcontractor 4 physically distant from firm 3. Moreover, system 1 described above is extremely cheap, and calls for no particular installation work at the subcontractor 4 plant: pickup devices 5 and sheets 21 may be supplied by firm 3 to subcontractor 4 for as long as required to produce one lot of parts 2, and then returned when production is completed. Logistically, production process control is run entirely by firm 3, who thus retains full control of the production process, with absolutely no burden being placed on subcontractor 4.

1. A method of remote controlling the current status of the production process of an article having a number of production process steps; the method comprising the steps of:
communicating by means of a pickup device (5) confirmation of completion of a production process step to a central control unit (6) having a database (7); and
storing the current status of the production process of the article (2) in the database (7);
the method is characterized in comprising the steps of:
reading at first code (20) using the pickup device (5) to store in the pickup device (5) a first sequence (12) identifying the production process step;
reading a second code (18) using the pickup device (5) to store in the pickup device (5) a second sequence (13) identifying the article (2);
coding confirmation of completion in an alphanumeric code (10) inside the pickup device (5) by combining the first sequence (12) and the second sequence (13);
inserting the code (10) into an SMS message (9) inside the pickup device (5); and
sending the SMS message (9) to the central control unit (6) over a mobile telephone network (11) by using the pickup device (5).

2. A method as claimed in claim 1, wherein the first code (20) is a bar code printed on a sheet (21) together with further first bar codes (20) relative to other production process steps.

3. A method as claimed in claim 2, wherein a description (22) of the relative production process step is printed an the sheet (21), close to the first bar code (20).

4. A method as claimed in claim 3, wherein the description (22) comprises verbal and/or pictorial information.

5. A method as claimed in claim 1, wherein the second code (18) is a bar code printed on a label (19) associated with the Article (2).

6. A method as claimed in claim 1, wherein, on receiving the SMS message (9) containing the code (10) from the pickup device (5), the central control unit (6) sends the pickup device (5) a further SMS message confirming reception.

7. A method as claimed in claim 6, wherein the pickup device (5) only eliminates the SMS message (9) containing the code (10) from its memory upon receiving from the central control unit (6) the respective further SMS message-confirming reception.

8. A system for remote controlling the production process of an article; the system (1) comprising:
a pickup device (5) for receiving confirmation of completion of a production process step from an operator; and
a central control unit (6) connected to the pickup device (5) and which stores the current status of the production process of the article (2) in a database (7);
the system is characterized in that the pickup device (5) comprises a first mobile telephone communication device (8) which communicates with the central control unit (6) by sending SMS messages (9); the pickup device (5) codes confirmation of completion in an alphanumeric code (10), inserts the code (10) into an SMS message (9), and sends the SMS message (9) to the central control unit (6) over a mobile telephone network (11); the code (10) comprises at first sequence (12), which identifies the production process step and is communicated to the pickup device (5) by the pickup device (5) reading a relative first code (20); and the code (10) comprises a second sequence (13), which identifies the article (2) and is communicated to the pickup device (5) by the pickup device (5) reading a relative second code (18).

9. A system as claimed in claim 8, wherein the first code (20) is a bar code printed on a sheet (21) together with farther first bar codes (20) relative to other production process steps.

10. A system as claimed in claim 9, wherein a description (22) of the relative production process step is printed on the sheet (21), close to the first bar code (20).

11. A system as claimed in claim 10, wherein the description (22) comprises verbal and/or pictorial information.

12. A system as Claimed in claim 8, wherein, the second code (18) is a bar code printed on a label (19) associated with the Article (2).

13. A system as claimed in claim 8, wherein, on receiving the SMS message (9) containing the code (10) from the pickup device (5), the central control unit (6) sends the pick up device (5) a further SMS message confirming reception.

14. A system as claimed in claim 13, wherein the pickup device (5) only eliminates the SMS message (9) containing the code (10) from its memory upon receiving from the central control unit (6) the respective further SMS message confirming reception.

15. A system as claimed in claim 8, wherein the pickup device (5) is defined by a s cellular telephone (8) having a code reading device (14).

16. A system as claimed in claim 15, wherein the code reading device (14) is detachable from the cellular telephone (8), and has a first communication port (15) which fits in a second communication port (16) on the cellular telephone (8) when the code reading device (14) is fitted to the cellular telephone (8).

17. A system as claimed in claim 8, wherein the central control unit (6) comprises an interface computer (23) having a second mobile telephone is communication device (24); and a main computer (25) in which the database (7) is stored.
